(19) United States
(12) Patent Application Publication
(10) Pub. No.: US 2007/0068975 A1
(43) Pub. Date: Mar. 29, 2007

(54) Foam throttle

(76) Inventors: Karl Batschied, Wilhelmsfeld (DE); Juergen Blaess, Hirschberg/Leutershausen (DE); Kurt Oberhofer, Wilhelmsfeld (DE)

Correspondence Address: Thomas M. Galgano, Esq.;GALGANO & ASSOCIATES, PLLC, Suite 204, 20 West Park Avenue, Long Beach, NY, 11561, US

(21) Appl. No.: 10/567,007

(22) PCT Filed: Jul. 1, 2004
(86) PCT No.: PCT/DE04/01385

§ 371 Date: Oct. 12, 2006

(30) Foreign Application Priority Data
Aug. 1, 2003 (DE) 103 36 009.3

(51) Int. Cl. B67D 3/04; B67D 1/14

(52) U.S. Cl. 222/484; 222/522; 222/523

(57) ABSTRACT

A tap for removing liquid from a container has a sleeve (10) made of plastic, in which a piston (12) is guided, and which sleeve has a passage opening (28) for the liquid. A hood that can be set onto the sleeve (10) in front of the passage opening (28), so that it covers the passage opening (28), serves as a foam throttle. The hood encloses a labyrinth channel (36), together with the sleeve, which channel is open at one end, towards the interior of the container, and ends in the passage opening (28) at the other end.

The invention relates to a foam throttle for a tap for removing liquid from a container, having a sleeve made of plastic, in which a piston is guided, and which has a passage opening for the liquid, which the piston seals off tightly in a locking position, in which it is moved in, and releases in a removing position, in which it is moved out.

Such taps are known from DE 198 25 929 A1, WO 02/072 469 A1, and WO 02/090 239 A1. They are mainly used for removing liquids that have been filled into containers under pressure, and are carbonated, particularly beverages, from kegs, small kegs (party kegs), or cans. This particularly involves party kegs for beer.

Beer is traditionally tapped with CO₂, under excess pressure. This technique is widespread in the restaurant business. It has the advantage that the beer comes to the consumer essentially saturated with CO₂. This is unexcelled for freshness, high quality, and flavor of the beer.

Party kegs for beer were originally intended to pursue the concept of bringing the tapping technique with CO₂ into household use. There are tap fittings with CO₂ cartridges that have a tapping pipe that is introduced through a bunghole at the top cap of the party keg all the way to its base. CO₂ under excess pressure is fed into the head space of the keg, in order to drive the beer up through the tapping pipe and dispense it. In this connection, the quality of the beer can be impaired, since the CO₂ excess pressure is not regulated. If the pressure is too low, CO₂ will gas out of the beer, and the beer will go flat. If the pressure is too high, over-carbonation of the beer will occur, accompanied by a deterioration of the flavor. Many consumers also hesitate to handle CO₂ cartridges and to tap beer kegs with them, because they consider it to be complicated and expensive.

A party keg can be emptied without CO₂, under the effect of gravity, with simultaneous pressure equalization. For this purpose, a tap of the type stated initially, which is integrated into a party keg, was developed. The tap is used, together with a pressure equalization valve that is operated by hand, in a bunghole at the top cap of the keg. The consumer can ventilate the keg by way of the valve, and bring about emptying without pressure, simply by means of gravity.

A disadvantage in this connection is that the beer comes into contact with oxygen, and that CO₂ gases out of the beer. Remedy is seen in a CO₂ dispenser that is located in the interior of the party keg and gives off a regulated CO₂ excess pressure into the head space of the keg, when it is tapped for the first time. The CO₂ dispenser is activated by the user in the same manner as the pressure equalization valve at the cap of the keg is presently activated. The CO₂ excess pressure guarantees that the CO₂ that is present in the beer remains in solution and no oxygen gets into the head space of the keg.

For the CO₂ excess pressure in the head space of the keg, a value of approximately 0.6 to 0.8 bar is aimed at. As compared with the current state of emptying the keg solely by means of gravity, with pressure equalization at atmospheric pressure, this is a significant increase in the feed pressure. The consequence is that practically all that is tapped is foam.

It is the task of the invention to create a foam throttle with which a tap of the type stated initially can be retrofitted in simple manner, with easy installation, and can be adapted, if necessary, to a tap with CO₂ under excess pressure, so that beer and foam are dispensed in an appropriate ratio.

The foam throttle that accomplishes this task consists of a hood that can be set onto the sleeve of the tap in front of the passage opening, which covers the passage opening, which encloses a labyrinth channel, together with the sleeve, which channel is open at one end, towards the interior of the container, and ends in the passage opening at the other end.

In a preferred embodiment, the labyrinth channel has a meander-shaped progression.

In a preferred embodiment, the open end of the labyrinth channel is located close to the outer end of the sleeve. This is of significance for complete emptying of the container. The tap is disposed closely above the base of the container, which is tilted to remove the remainder of the liquid. In this connection, a liquid level must be present at the open end of the labyrinth channel.

The labyrinth channel can be configured both on the outer mantle of the sleeve and on the inner mantle of the hood. In the case of the latter embodiment, the labyrinth channel can end in a tapping bore through the hood, or run out on a face of the hood. In this variant, the opening of the labyrinth channel is located even closer to the end of the sleeve.

In a preferred embodiment, the hood can be clipped onto the sleeve. The hood can be both fully cylindrical and partially cylindrical. In the latter variant, the hood has a looping angle of more than 180°, preferably approximately 220°. In this way, it holds tight to the sleeve by means of inherent elasticity, with slight spreading.

In a preferred embodiment, the sleeve is provided with ribs on its outer mantle. The hood of the foam throttle has recesses that fit over these ribs, for the purpose of positioning.

The invention will be explained in greater detail in the following, using two exemplary embodiments shown in the drawing. This shows:

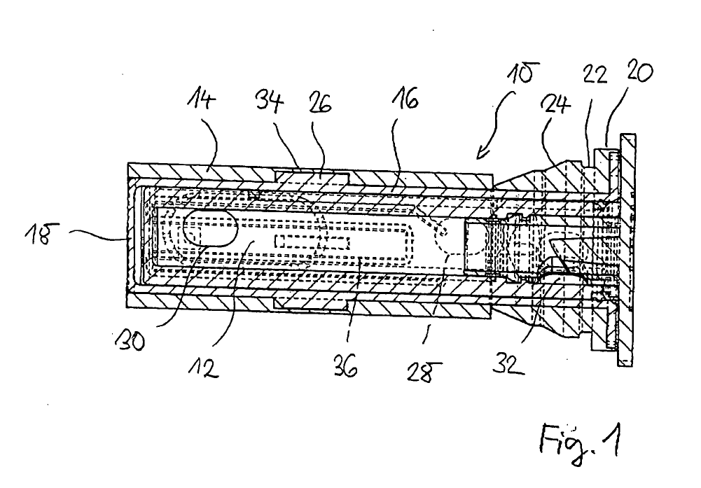

FIG. 1 a side view of a tap having a sleeve, a piston that is fitted into the latter, and a foam throttle clipped onto the sleeve;

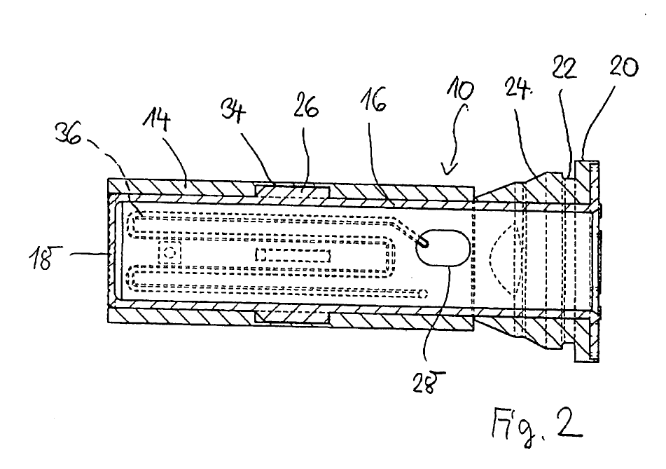

FIG. 2 as a detail, a side view of the sleeve with the foam throttle alone;

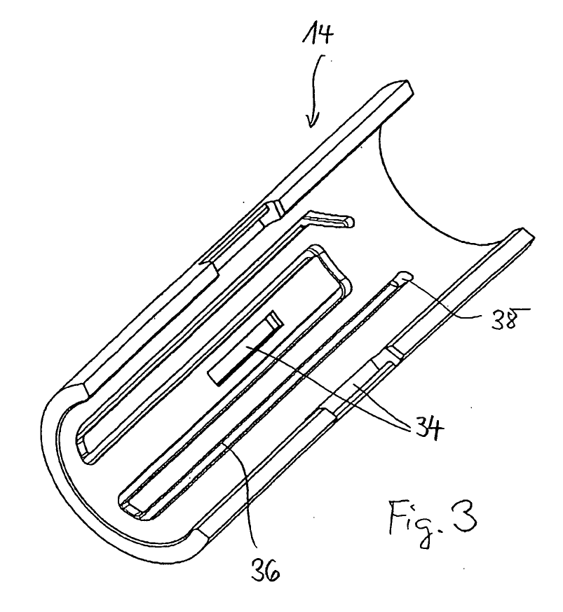

FIG. 3 a perspective view of the foam throttle, looking towards the inside of the latter; and

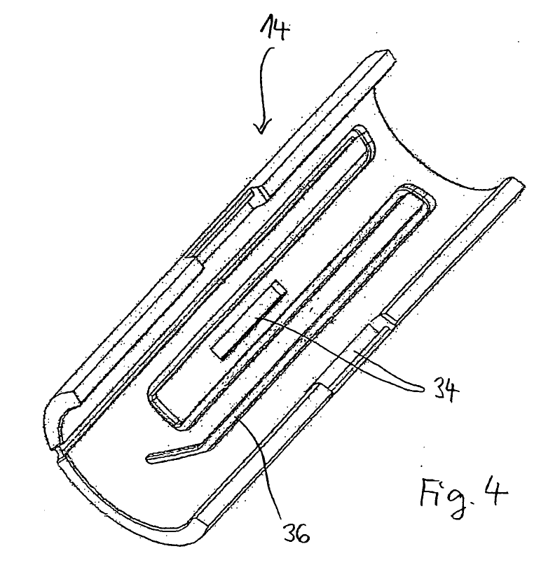

FIG. 4 a perspective view of a modified foam throttle.

The tap consists of a sleeve 10, a piston 12, and a foam throttle 14.

The sleeve 10 has a circular cylindrical beaker body 16, the base 18 of which is closed off at its inner end. At the outer end of the sleeve 10, a bung of elastic material is molded on, which widens conically, and has a flange-like outer contact part 20, a circumferential sealing part 22 that is recessed behind the former, and a conical engagement part 24 that is located ahead of the sealing part 22, the diameter of which is greater than that of the sealing part 22.

The tap is pressed into the round opening of a container that contains liquid to be tapped, as a completely pre-assembled unit of sleeve 10, piston 12, and foam throttle 14. This involves a liquid that was filled into the container without pressure or under pressure, which can be carbonated. Specifically, this involves the tapping of beverages, particularly beer, from kegs, small kegs (party kegs), or cans. The tap is pressed into the opening of the container with the beaker body 16 and the conical engagement part 24 of the sleeve 10 going first. The circumferential sealing part 22 accommodates the edge of the opening, forming a seal, so that it comes to rest between the flange-like contact part 20 and the engagement part 24 of the sleeve 10, with which the latter engages at the edge of the opening.

To align the sleeve 10 with reference to the piston 12 during assembly of the tap, four ribs 26 uniformly offset over the circumference are molded onto the outer mantle of its beaker body 16, which ribs extend in the longitudinal direction of the sleeve 10.

The sleeve 10 has a passage opening 28 for the liquid to be tapped in the mantle wall of its beaker body. The piston is a cylindrical hollow body, the mantle wall of which has an entry opening 30 on the inner piston end, and an exit opening 32 for the liquid at its outer piston end. Before the keg is tapped for the first time, the piston 12 assumes a locking position in which it is moved into the sleeve 10 (see FIG. 1), in which it tightly closes off the passage opening 28 of the sleeve 10. By means of withdrawing the piston 12 from the sleeve 10, the entry opening 30 arrives at the level of the passage opening 28, and liquid flows through the interior of the piston to its exit opening 32.

The foam throttle 14 is a partially cylindrical hood made of plastic. The hood is clipped onto the outside of the beaker body 16 of the sleeve 10 in front of the passage opening 28, so that it covers the passage opening 28. The hood has a looping angle of approximately 220°. It sits tightly on the beaker body 16 of the sleeve 10 by means of its inherent elasticity, being slightly spread open.

The hood of the foam throttle 14 has recesses 34 in which three of the four ribs 26 on the outer mantle of the beaker body 16 fit. The foam throttle 14 is positioned by means of the engagement of the ribs 26 in the recesses 34.

The hood of the foam throttle 14 has a labyrinth channel 36 having a meander-shaped progression, on the inside. The labyrinth channel 36 ends in the passage opening 28 of the sleeve 10 on the one end. In the variant according to FIG. 1 to FIG. 3, the other end of the labyrinth channel 36 leads into a tapping bore 38 that passes crosswise through the hood. The tapping bore 38 is located at the outer end of the sleeve 10, not far from the passage opening 28. In the variant according to FIG. 4, the labyrinth channel runs out on the face of the hood.

### LIST OF REFERENCE SYMBOLS

10 sleeve
12 piston
14 foam throttle
16 beaker body
18 base
20 contact part
22 sealing part
24 engagement part
26 rib
28 passage opening
30 entry opening
32 exit opening
34 recess
36 labyrinth channel
38 tapping channel

1. Foam throttle for a tap for removing liquid from a container comprising a sleeve made of plastic, in which a piston is guided, and which has a passage opening for the liquid, which the piston seals off tightly in a locking position, in which it is moved in, and releases in a removing position, in which it is moved out, and a hood that can be set onto the sleeve in front of the passage opening, which covers the passage opening, which encloses a labyrinth channel, together with the sleeve, which channel is open at one end, towards the interior of the container, and ends in the passage opening at the other end.

2. Foam throttle according to claim 1, wherein the labyrinth channel has a meander-shaped progression.

3. Foam throttle according to claim 1, wherein the open end of the labyrinth channel is located close to the outer end of the sleeve.

4. Foam throttle according to claim 1, wherein the labyrinth channel is configured on the outer mantle of the sleeve.

5. Foam throttle according to claim 1, wherein the labyrinth channel is configured on the inner mantle of the hood.

6. Foam throttle according to claim 1, wherein the labyrinth channel ends in a tapping bore through the hood.

7. Foam throttle according to claim 1, wherein the labyrinth channel runs out on a face of the hood.

8. Foam throttle according to claim 1, wherein the hood can be clipped onto the sleeve.

9. Foam throttle according to claim 1, wherein the hood is fully cylindrical.

10. Foam throttle according to claim 1, wherein the hood is partially cylindrical and has a looping angle of more than 180°, preferably approximately 220°.

11. Foam throttle according to claim 1, wherein the sleeve is provided with ribs on its outer mantle, and that the hood has recesses that fit over the ribs.
